(19) United States
(12) Patent Application Publication
(10) Pub. No.: US 2010/0062265 A1
(43) Pub. Date: Mar. 11, 2010

(54) Titanium Dioxide Coatings and Methods of Forming Titanium Dioxide Coatings Having Reduced Crystallite Size

(75) Inventor: PRAMOD K. SHARMA, Ann Arbor, MI (US)

Correspondence Address: O'BRIEN JONES, PLLC, 8200 Greensboro Drive, Suite 1020A, McLean, VA, 22102, US

(73) Assignee: GUARDIAN INDUSTRIES CORP., Auburn Hills, MI (US)

(21) Appl. No.: 12/207,235

(22) Filed: Sep. 9, 2008

(51) Int. Cl. B32B 17/06; B05D 3/02

(52) U.S. Cl. 428/432; 427/372.2

(57) ABSTRACT

Methods for forming titanium dioxide coatings having crystals comprising reduced crystallite size are disclosed. Sol-gel compositions are prepared, formed on a substrate, and the coated substrate is heated at a temperature sufficient to form a titanium dioxide coating with crystals having a reduced crystallite size. Titanium dioxide coatings having crystals comprising reduced crystallite size and having at least one of improved antimicrobial properties, self-cleaning properties, and/or hydrophilicity are also disclosed. Substrates comprising such coatings are also disclosed.

### FIELD

The present invention relates generally to titanium dioxide coatings and methods of forming titanium dioxide coatings having improved photocatalytic activity, such as by reducing crystallite size.

### BACKGROUND

Titanium dioxide (TiO₂, also know as titania) has been widely studied because of its potential photocatalytic applications. Titanium dioxide only absorbs ultraviolet (UV) radiation. When UV light is illuminated on titanium dioxide, electron-hole pairs are generated. Electrons are generated in the conduction band and holes are generated in the valence band. The electron and hole pairs reduce and oxidize, respectively, adsorbates on the surface of the titanium dioxide, producing radical species such as OH⁻ and O₂⁻. Such radicals may decompose certain organic compounds or pollutants, for example by turning them into non-harmful inorganic compounds. As a result, titanium dioxide coatings have found use in antimicrobial and self-cleaning coatings.

To activate the titanium dioxide to photogenerate these electron-hole pairs (i.e., photocatalytic activity), and thus to provide the titanium dioxide with antimicrobial and/or self-cleaning properties, titanium dioxide must be regularly dosed with photons of energy greater than or equal to 3.0 eV (i.e., radiation having a wavelength less than 413 nm). Depending on variables such as the structure, ingredients, and texture of titanium dioxide coatings, for example, dosing may take several hours, such as, for example, 6 hours or more. Antimicrobial titanium dioxide coatings, therefore, must generally be exposed to UV radiation for at least about 6 hours before achieving the full photocatalytic effect.

Efforts have been made to extend the energy absorption of titanium dioxide to visible light and to improve the photocatalytic activity of titanium dioxide. For example, foreign metallic elements such as silver can be added. This may, for example, aid electron-hole separation as the silver can serve as an electron trap, and can facilitate electron excitation by creating a local electric field.

Furthermore, titanium dioxide also has been shown to exhibit highly hydrophilic properties when exposed to UV radiation. Such hydrophilicity may be beneficial in certain embodiments, such as, for example, certain coating embodiments. Without wishing to be limited in theory, it is believed that the photoinduced hydrophilicity is a result of photocatalytic splitting of water by the mechanism of the photocatalytic activity of the titanium dioxide, i.e., by the photogenerated electron-hole pairs. When exposed to UV radiation, the water contact angle of titanium dioxide coatings approaches 0°, i.e., superhydrophilicity.

Current coating methods involving titanium dioxide often result in a disadvantageous loss of hydrophilicity and/or photocatalytic activity (and thus antimicrobial and/or self-cleaning properties) of the titanium dioxide. This may be due to formation of different phases of the titanium dioxide during the coating process. For example, anatase titanium dioxide typically transforms to rutile phase titanium dioxide when heated at temperatures greater than 600° C., such as may be used during the coating process or when a titanium dioxide coated substrate is tempered. The rutile phase has less desirable surface coating properties than the anatase phase, such as, for example, less desirable hydrophilicity and antimicrobial and/or self-cleaning properties.

There is thus a long-felt need in the industry for methods for forming a titanium dioxide coating having increased photocatalytic activity such as antimicrobial and/or self-cleaning properties and/or hydrophilicity, and/or a reduced dosing time. The invention described herein may, in some embodiments, solve some or all of these needs.

### SUMMARY

In accordance with various exemplary embodiments of the invention, methods for improving at least one of the hydrophilicity and photocatalytic activity such as antimicrobial and/or self-cleaning properties of titanium dioxide coatings have now been discovered.

At least one exemplary embodiment of the invention relates to methods for forming titanium dioxide coatings comprising crystals having reduced crystallite size in order to improve at least one of photocatalytic activity (and thus antimicrobial and/or self-cleaning properties) and hydrophilicity of the titanium dioxide coatings. Additional exemplary embodiments relate to titanium dioxide coatings comprising crystals having reduced crystallite size.

Exemplary methods comprise, for example, preparing a sol-gel composition, coating a substrate with the sol-gel composition, and then heating the coating to form a titanium dioxide coating comprising crystals having reduced crystallite size.

Further exemplary embodiments of the invention relate to antimicrobial and/or self-cleaning coatings comprising anatase titanium dioxide coatings. Additional exemplary embodiment comprises anatase titanium dioxide coatings having improved hydrophilicity. Further embodiments also include a substrate coated with a titanium dioxide coating according to various exemplary embodiments of the invention

As used herein, “increased” or “improved photocatalytic activity” means any decrease in the activation time of, or any increase in the amount of organic material decomposed by, the titanium dioxide coating in a specified period of time when compared to titanium dioxide coatings not according to various embodiments of the invention. Similarly, “increased” or “improved antimicrobial properties” or “increased” or “improved self-cleaning properties” likewise mean any increase in the amount of organic material decomposed by the titanium dioxide coating in a specified period of time when compared to titanium dioxide coatings not according to various embodiments of the invention.

Throughout this disclosure, the terms “photocatalytic activity,” “antimicrobial properties,” and/or “self-cleaning properties” may be used interchangeably to convey that the antimicrobial and/or self-cleaning properties of the titanium dioxide coatings are a result of the photocatalytic activity of the coatings.

As used herein, “activation time” means the time required for a titanium dioxide coating illuminated with UV radiation to decompose a specified percentage of organic material over a period of time.

As used herein, “increased” or “improved hydrophilicity” means any decrease in the water contact angle when compared to titanium dioxide coatings not according to various embodiments of the invention. The water contact angle is a measure of the angle between water and the surface of a material. A smaller water contact angle indicates a material that is more hydrophilic than a material with a higher water contact angle. Water droplets on more hydrophilic surfaces tend to spread out or flatten, whereas on less hydrophilic surfaces water tends to bead up or form droplets which are more spherical in shape, and the water contact angle of those surfaces is generally greater.

As used herein, “crystallite size” means the average size of anatase phase crystals in the titanium dioxide coating. A titanium dioxide coating having “reduced crystallite size” or “comprising crystals having reduced crystallite size” includes those coatings with average crystallite size smaller than coatings not according to various embodiments of the invention. Crystallite size may be determined by any method known to those of skill in the art. For example, in one exemplary embodiment crystallite size can be determined by the x-ray diffraction pattern using Scherer's crystallite size formula (Equation 1).

$$L = \frac{K \times λ}{{B}_{1 / 2} cos θ} . \qquad ( 1 )$$

wherein L is the crystallite size in nm, K is a constant (0.8), λ is the wavelength of the x-ray source (0.1541 nm for Cu), B_{1/2} is the half height and half width of (100) peak, and θ is the peak of (100) at θ.

As used herein, the term “sol-gel composition” means a chemical solution comprising a titanium compound that forms a polymer when the solvent is removed, for example by heating or any other means known to those skilled in the art.

As used herein, the term “temperable” means a titanium dioxide coating that may be heated to a temperature sufficient to temper a substrate on which it is formed without forming rutile phase titanium dioxide.

As described herein, the invention relates to titanium dioxide coatings and methods of forming titanium dioxide coatings comprising crystals having reduced crystallite size. In the following description, certain aspects and embodiments will become evident. It should be understood that the invention, in its broadest sense, could be practiced without having one or more features of these aspects and embodiments. It should be understood that these aspects and embodiments are merely exemplary and explanatory, and are not restrictive of the invention as claimed.

### BRIEF DESCRIPTION OF THE DRAWINGS

The following figures, which are described below and which are incorporated in and constitute a part of the specification, illustrate exemplary embodiments of the invention and are not to be considered limiting of the scope of the invention, for the invention may admit to other equally effective embodiments.

FIG. 1 is an absorbance spectrum of the titanium dioxide coating of the Comparative Example at various time intervals of UV illumination;

FIG. 2 is an absorbance spectrum of the titanium dioxide coating of Example 1 at various time intervals of UV illumination;

FIG. 3 is an absorbance spectrum of the titanium dioxide coating of Example 2 at various time intervals of UV illumination;

FIG. 4 is an absorbance spectrum of the titanium dioxide coating of Example 3 at various time intervals of UV illumination;

FIG. 5 is an absorbance spectrum of the titanium dioxide coating of Example 4 at various time intervals of UV illumination;

FIG. 6 is an absorbance spectrum of the titanium dioxide coating of Example 5 at various time intervals of UV illumination

FIG. 7 is a graph of the water contact angle of exemplary titanium dioxide coatings of the invention as a function of the crystallite size of the exemplary titanium dioxide coatings; and

FIG. 8 is a graph of the stearic acid decomposition on exemplary titanium dioxide coatings as a function of the crystallite size of the titanium dioxide coatings.

### DESCRIPTION OF EXEMPLARY EMBODIMENTS

Reference will now be made to various exemplary embodiments of the invention, examples of which are illustrated in the accompanying figures. However, these various exemplary embodiments are not intended to limit the disclosure, but rather numerous specific details are set forth in order to provide a thorough understanding of the invention. However, it will be apparent to one skilled in the art that the invention may be practiced without some or all of these specific details, and the disclosure is intended to cover alternatives, modifications, and equivalents. For example, well-known features and/or process steps may not have been described in detail so as not to unnecessarily obscure the invention.

The present invention contemplates exemplary methods for forming titanium dioxide coatings comprising crystals having reduced crystallite size in order to improve photocatalytic activity such as antimicrobial and/or self-cleaning properties and/or hydrophilicity of the coating.

While not wishing to be bound by theory, it is believed that the decreased crystallite size of the crystals of the titanium dioxide coating leads to a greater surface area. The greater surface area may, for example, lead to a greater number of radicals which form on the titanium dioxide coating, which in turn may lead to (1) improved photocatalytic activity such as antimicrobial and/or self-cleaning properties because the number of radicals may be directly related to the amount of surface area available, and/or (2) improved hydrophilicity because the number of radicals which are present and are available to be attracted to the water molecules is greater.

One exemplary method in accordance the invention comprises preparing a sol-gel composition comprising a titanium compound, coating a substrate with the sol-gel composition, and heating the coating to form a titanium dioxide coating having reduced crystallite size.

In at least one embodiment, the sol-gel composition comprises a titanium alkoxide or a titanium chloride. Examples of titanium alkoxides which may be used in sol-gel compositions according to the present invention include, but are not limited to, titanium n-butoxide, titanium tetra-iso-butoxide (TTIB), titanium isopropoxide, and titanium ethoxide. In at least one embodiment, the sol-gel composition comprises titanium tetra-iso-butoxide.

In at least one embodiment, the sol-gel composition further comprises a surfactant, which may improve the coating process. Examples of surfactants which may be used in accordance with the present invention include, but are not limited to, non-ionic surfactants such as alkyl polysaccharides, alkylamine ethoxylates, castor oil ethoxylates, ceto-stearyl alcohol ethoxylates, decyl alcohol ethoxylates, and ethylene glycol esters.

Various exemplary methods in accordance with the invention may reduce crystallite size of the titanium dioxide coatings and/or may improve at least one of hydrophilicity and photocatalytic activity such as antimicrobial and/or self-cleaning properties of the coatings.

In various exemplary embodiments, the titanium dioxide coatings comprising crystals having reduced crystallite size may be formed on a substrate. Accordingly, substrates coated with a titanium dioxide coating according to various exemplary embodiments of the invention are also contemplated herein. One of skill in the art will readily appreciate the types of substrates which may be coated with exemplary coatings as described herein.

In one exemplary embodiment, the substrate may comprise a glass substrate. In various exemplary embodiments, the glass substrate may be chosen from standard clear glass, such as float glass, or a low iron glass, such as ExtraClear™, UltraWhite™, or Solar glasses available from Guardian Industries.

In at least one embodiment, the substrate, such as glass, is coated with a sol-gel composition, and heated at a temperature sufficient to reduce the titanium dioxide crystallite size. In at least one embodiment, the sol-gel coated substrate is heated at a temperature of about 500° C. or greater. The substrate may, in certain embodiments, be heated for up to 3 hours. In at least one other embodiment, the sol-gel coated substrate is heated at a temperature of about 625° C. or greater. The substrate may, in certain embodiments, be heated for about 3-4 minutes, such as about 3½ minutes. One skilled in the art will appreciate that other temperatures and heating times may be used and should be chosen such that anatase titanium dioxide is formed. For example, titanium dioxide coatings may be heated at a temperature ranging from about 550° C. to about 650° C. Titanium dioxide coatings may be heated at lower temperatures as well, as long as anatase titanium dioxide is formed. One skilled in the art may choose the temperature and heating time based on, for example, the appropriate temperature and time for heating to form the titanium dioxide coating comprising crystals having reduced crystallite size, the properties of the desired titanium dioxide coating, such as thickness of the coating or thickness of the substrate, etc. For example, a thinner coating may require heating at a lower temperature or for a shorter time than a thicker coating. Similarly, a substrate that is thicker or has lower heat transfer may require a higher temperature or a longer time than a substrate that is thinner or has a high heat transfer. As used herein, the phrase “heated at” a certain temperature means that the oven or furnace is set at the specified temperature. Determination of the appropriate heating time and temperature is well within the ability of those skilled in the art, requiring no more than routine experimentation.

In at least one embodiment, the substrate may be coated with the sol-gel composition by a method chosen from spin-coating the sol-gel composition on the substrate, spray-coating the sol-gel composition on the substrate, and dip-coating the substrate with the sol-gel composition, or any other method known to those of skill in the art.

Temperable anatase titanium dioxide coatings may be formed according to at least one method of the present invention. For example, an anatase titanium dioxide coating formed on a glass substrate may be heated at a temperature sufficient to temper the glass substrate without forming the rutile phase of titanium dioxide, i.e., the titanium dioxide remains in the anatase phase when the glass substrate is tempered.

The present invention also contemplates, in at least one embodiment, a titanium dioxide coating with reduced crystallite size having improved hydrophilicity, such as, for example, when formed on a substrate. For example, the titanium dioxide coating with reduced crystallite size may have a water contact angle, when exposed to UV radiation, less than 10°, such as less than about 7°.

In at least one embodiment of the present invention, an anatase titanium dioxide coating comprises titanium dioxide crystals having a crystallite size less than about 35 nm, such as less than about 25 nm.

The present invention is further illustrated by the following non-limiting examples, which are provided to further aid those of skill in the art in the appreciation of the invention.

Unless otherwise indicated, all numbers herein, such as those expressing weight percents of ingredients and values for certain physical properties, used in the specification and claims are to be understood as being modified in all instances by the term “about,” whether so stated or not. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, a “wt %” or “weight percent” or “percent by weight” of a component, unless specifically stated to the contrary, is based on the total weight of the composition or article in which the component is included. As used herein, all percentages are by weight unless indicated otherwise.

It is noted that, as used in this specification and the appended claims, the singular forms “a,” “an,” and “the,” include plural referents unless expressly and unequivocally limited to one referent, and vice versa. Thus, by way of example only, reference to “a substrate” can refer to one or more substrates, and reference to “a titanium dioxide coating” can refer to one or more titanium dioxide coatings. As used herein, the term “include” and its grammatical variants are intended to be non-limiting, such that recitation of items in a list is not to the exclusion of other like items that can be substituted or added to the listed items.

It will be apparent to those skilled in the art that various modifications and variation can be made to the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

### EXAMPLES

### Comparative Example

A titanium dioxide sol was prepared by mixing 6 g of titanium tetra-iso-butoxide (TTIB) in a solution containing 25 g of ethanol and 2 g of nitric acid. The mixture was stirred for 1 h. The pure titanium dioxide coating was fabricated by spin coating a glass substrate at 700 rpm for 30 s. The coating was heat treated in a furnace at 450° C. for 3½ min. The formed titanium dioxide coating was amorphous. The anatase phase of the titanium dioxide had not yet started to crystallize on heating at 450° C. The amorphous titanium dioxide coating had a water contact angle of 39.47°.

The photocatalytic activity of the examples disclosed herein was tested using a stearic acid test that measured the degradation of stearic acid on the anatase titanium dioxide coatings. To perform the stearic acid test, an 8.8×10⁻³ M stearic acid/methanol solution was prepared. The stearic acid/methanol solution was spin coated on the surface of the anatase titanium dioxide coating at 2000 rpm for 30 sec. The stearic acid concentration was measured with a Nicolet 6700 FT-IR spectrometer by integrating the absorption peaks of the stearic acid molecule between 2700 and 3100 cm⁻¹. Stearic acid concentration was then measured at various time intervals of UV illumination of the anatase titanium dioxide coating. Two UV lamps with 1300 μW/cm² and wavelength of 340 nm were used for UV irradiation.

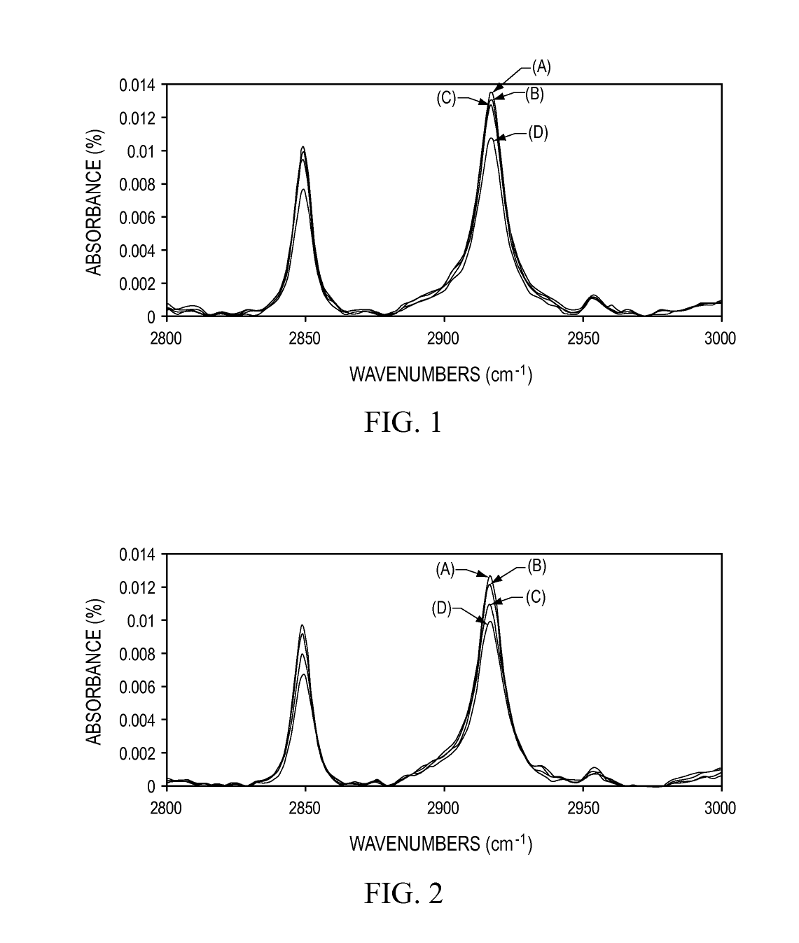

FIG. 1 shows the absorbance spectra of the pure anatase titanium dioxide coating of the Comparative Example. In each of the absorbance spectra shown in FIGS. 1-6, the spectra are labeled after UV illumination for (A) 0 h, (B) 2 h, (C) 5 h, and (D) 21 h.

As can be seen in FIG. 1, the absorbance peaks for stearic acid left on the coating after exposing the titanium dioxide coating of the Comparative Example to UV illumination for 21 hours, the stearic acid spectral peaks were 81.73% and 79.91% of the initial peaks for the peaks at 2920 cm⁻¹ and 2850 cm⁻¹, respectively.

### Example 1

The coating of Example 1 was prepared similar to the coating of the Comparative Example except that the coating was heat treated in a furnace at 500° C. for 3 h, which resulted in a crystalline anatase titanium dioxide coating. The water contact angle of the anatase titanium dioxide coating of Example 1 was 34.2°.

FIG. 2 is an absorbance spectrum of the anatase titanium dioxide coating of Example 1 at various time intervals of UV illumination. As seen in FIG. 2, the absorbance peaks of stearic acid on the anatase titanium dioxide coating of Example 1 after 21 hours of UV illumination were 79.07% and 70.78% of the initial peak size for the peaks at 2920 cm⁻¹ and 2850 cm⁻¹, respectively.

### Example 2

The coating of Example 2 was prepared similar to the coating of the Comparative Example except that the coating was heat treated in a furnace at 550° C. for 2 h, resulting in a crystalline anatase titanium dioxide coating. The water contact angle of the titanium dioxide coating of Example 2 was 26.21°.

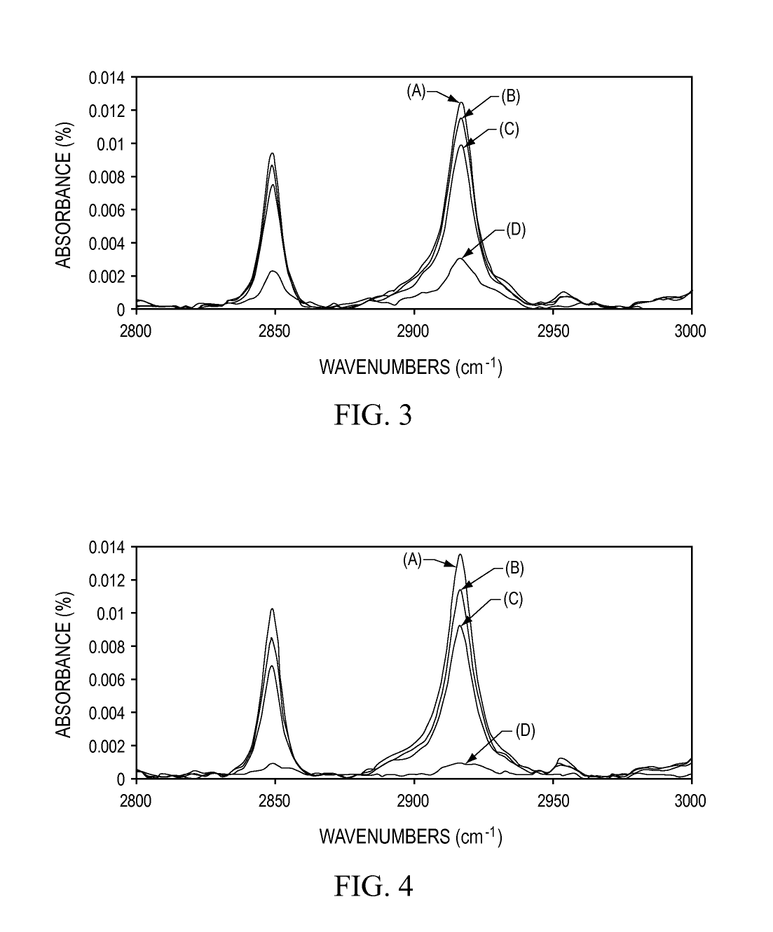

FIG. 3 is an absorbance spectrum of the titanium dioxide coating of Example 2 at various time intervals of UV illumination. As seen in FIG. 3, the absorbance peaks of stearic acid on the titanium dioxide coating of Example 2 after 21 hours of UV illumination were 28.77% and 22.42% of the initial peak size for the peaks at 2920 cm⁻¹ and 2850 cm⁻¹, respectively.

### Example 3

The coating of Example 3 was prepared similar to the coating of the Comparative Example except that the coating was heat treated in a furnace at 575° C. for 2 h, resulting in a crystalline anatase titanium dioxide coating. The water contact angle of the titanium dioxide coating of Example 3 was 9.72°.

FIG. 4 is an absorbance spectrum of the titanium dioxide coating of Example 3 at various time intervals of UV illumination. As seen in FIG. 4, the absorbance peaks of stearic acid on the titanium dioxide coating of Example 3 after 21 hours of UV illumination were 5.23% and 5.91% of the initial peak size for the peaks at 2920 cm⁻¹ and 2850 cm⁻¹, respectively.

### Example 4

The coating of Example 4 was prepared similar to the coating of the Comparative Example except that the coating was heat treated in a furnace at 600° C. for 3½ min, resulting in a crystalline anatase titanium dioxide coating. The water contact angle of the titanium dioxide coating of Example 4 was 9.54°.

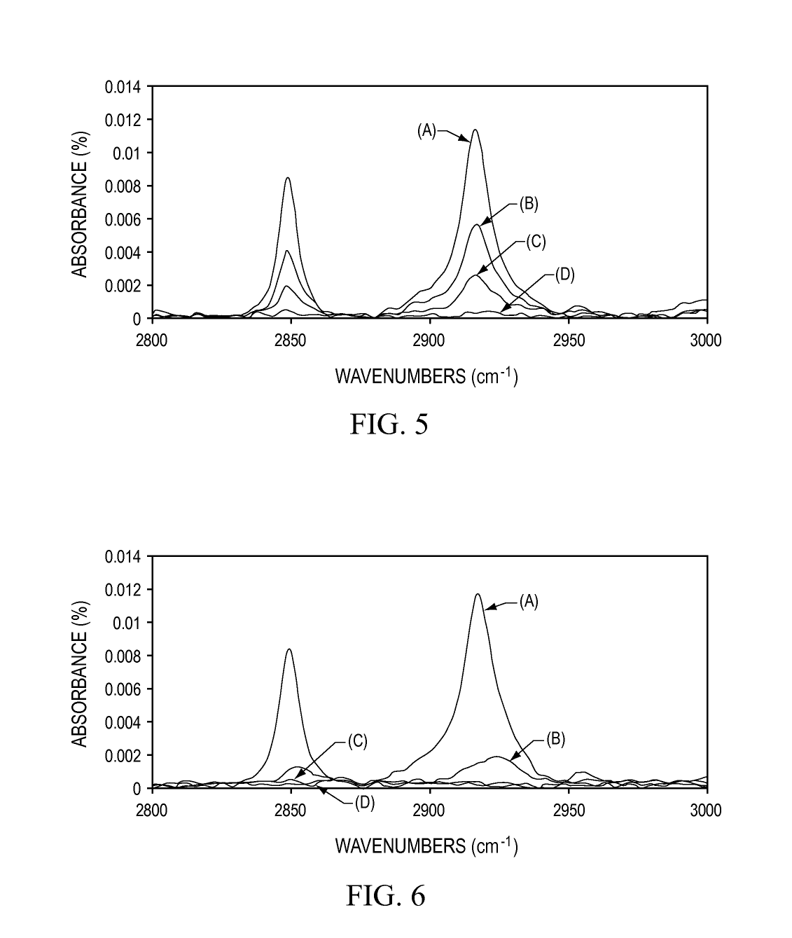

FIG. 5 is an absorbance spectrum of the titanium dioxide coating of Example 4 at various time intervals of UV illumination. As seen in FIG. 5, the absorbance peaks of stearic acid on the titanium dioxide coating of Example 4 after 21 hours of UV illumination were 2.74% and 3.83% of the initial peak size for the peaks at 2920 cm⁻¹ and 2850 cm⁻¹, respectively.

### Example 5

The coating of Example 5 was prepared similar to the coating of the Comparative Example except that the coating was heat treated in a furnace at 625° C. for 3½ min, resulting in a crystalline anatase titanium dioxide coating. The water contact angle of the titanium dioxide coating of Example 5 was 6.91°.

FIG. 6 is an absorbance spectrum of the titanium dioxide coating of Example 5 at various time intervals of UV illumination. As seen in FIG. 6, the absorbance peaks of stearic acid on the titanium dioxide coating of Example 5 after 21 hours of UV illumination were 1.32% and 1.66% of the initial peak size for the peaks at 2920 cm⁻¹ and 2850 cm⁻¹, respectively.

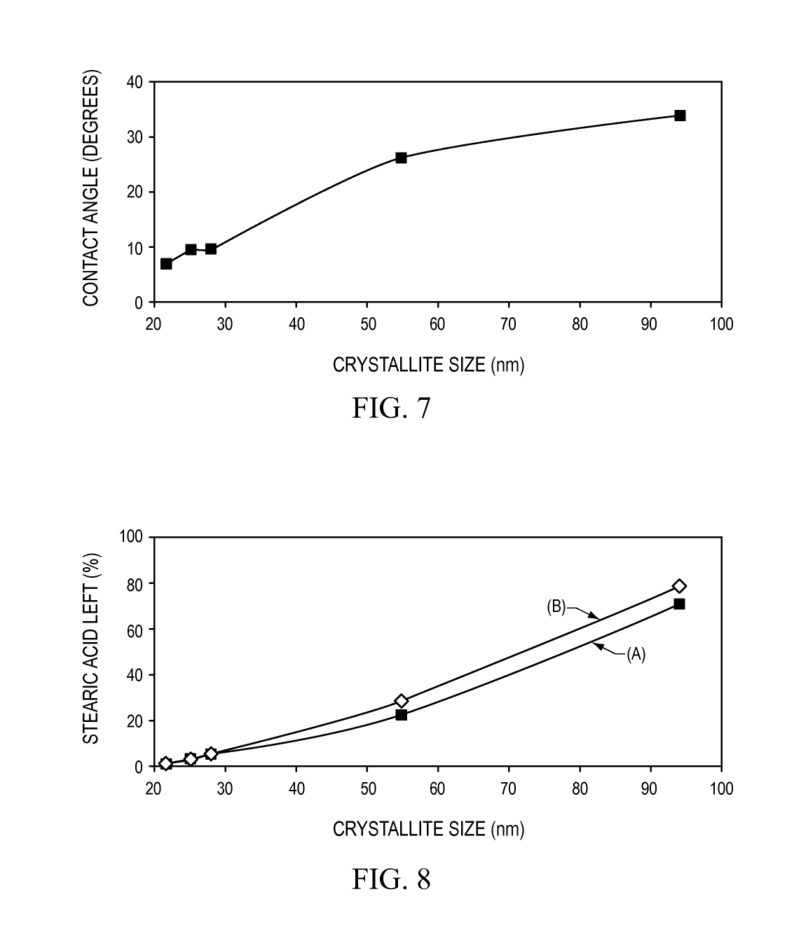

The water contact angle as a function of crystallite size is shown in FIG. 7. As can be seen in FIG. 7, the water contact angle decreases as the crystallite size of titanium dioxide decreases. Crystallite size is determined from its x-ray diffraction pattern using Scherer's crystallite size formula (Equation 1).

$$L = \frac{K \times λ}{{B}_{1 / 2} cos θ} \qquad ( 1 )$$

wherein L is the crystallite size in nm, K is a constant (0.8), λ is the wavelength of the x-ray source (0.1541 nm for Cu), B_{1/2} is the half height and half width of (100) peak, and θ is the peak of (100) at θ.

A graph depicting the degradation of stearic acid on the titanium dioxide coatings of the Comparative Example and Examples 1-5 after exposing the titanium dioxide coatings to UV radiation for 21 hours as a function of crystallite size is shown in FIG. 8. In FIG. 8, (A) represents the absorbance peak at 2920 cm⁻¹ and (B) represents the absorbance peak at 2850 cm⁻¹. As can be seen in FIG. 8, a decrease in crystallite size results in an increase in the amount of stearic acid degradation.

1. A method of forming a titanium dioxide coating comprising crystals having a reduced crystallite size on a substrate, comprising:
preparing a titanium dioxide sol-gel composition;
coating the substrate with the sol-gel composition; and
heating the coated substrate at a temperature sufficient to form a titanium dioxide coating comprising crystals having a reduced crystallite size.

2. The method of claim 1, wherein said coated substrate is heated at a temperature of at least 575° C.

3. The method of claim 2, wherein said coated substrate is heated at a temperature of at least about 600° C.

4. The method of claim 1, wherein the coated substrate is heated at a temperature sufficient to form a titanium dioxide coating comprising a water contact angle less than about 10°.

5. The method of claim 1, wherein the titanium dioxide coating comprises crystals having a crystallite size less than about 35 nm.

6. The method of claim 5, wherein the titanium dioxide coating comprises crystals having a crystallite size less than about 25 nm.

7. The method of claim 1, wherein the substrate comprises a glass substrate.

8. The method of claim 7, wherein the glass substrate is chosen from clear and low-iron glass.

9. A method of improving at least one of antimicrobial properties, self-cleaning properties, and hydrophilicity of a titanium dioxide coating, comprising:
preparing a titanium dioxide sol-gel composition;
coating a substrate with the sol-gel composition; and
heating the coated substrate to form a titanium dioxide coating comprising crystals having a reduced crystallite size.

10. The method of claim 9, wherein the coated substrate is heated at a temperature at least about 575° C.

11. The method of claim 10, wherein the coated substrate is heated at a temperature at least about 600° C.

12. The method of claim 9, wherein said crystals have a crystallite size less than about 35 nm.

13. The method of claim 12, wherein said crystals have a crystallite size less than about 25 nm.

14. The method of claim 9, wherein the titanium dioxide coating comprises a water contact angle less than about 10°.

15. A substrate comprising a titanium dioxide coating comprising crystals having a reduced crystallite size, wherein the titanium dioxide coating comprises crystals having a crystallite size less than about 35 nm.

16. The substrate comprising a titanium dioxide coating comprising crystals having a reduced crystallite size of claim 15, wherein the titanium dioxide coating comprises crystals having a crystallite size less than about 25 nm.

17. The substrate comprising a titanium dioxide coating comprising crystals having a reduced crystallite size of claim 15, wherein the titanium dioxide coating comprises a water contact angle less than about 10°.

18. The substrate comprising a titanium dioxide coating comprising crystals having a reduced crystallite size of claim 15, wherein the substrate comprises a glass substrate.

19. The antimicrobial coating of claim 18, wherein the glass substrate is chosen from clear and low iron glass.

20. A titanium dioxide coating having at least one of improved antimicrobial properties, improved self-cleaning properties, and improved hydrophilicity, wherein said titanium dioxide coating is made by:
preparing a titanium dioxide sol-gel composition;
coating a substrate with the sol-gel composition; and
heating the coated substrate to form a titanium dioxide coating comprising crystals having a reduced crystallite size.

21. A substrate comprising a titanium dioxide coating having a reduced crystallite size, wherein said titanium dioxide coating is made by:
preparing a titanium dioxide sol-gel composition;
coating the substrate with the sol-gel composition; and
heating the coated substrate at a temperature sufficient to form a titanium dioxide coating comprising crystals having a reduced crystallite size.
